(19) United States
(12) Patent Application Publication
(10) Pub. No.: US 2024/0361005 A1
(43) Pub. Date: Oct. 31, 2024

(54) VENTILATION HOOD AND PROCESS FOR MAKING SAME

(71) Applicant: Broan-NuTone LLC, Hartford, WI (US)

(72) Inventors: Jordan Bricco, Neosho, WI (US); Adan Gurrola, West Bend, WI (US); Tracy Krueger, Brookfield, WI (US); Chris Martin, Ixonia, WI (US)

(21) Appl. No.: 18/644,314

(22) Filed: Apr. 24, 2024

Related U.S. Application Data
(60) Provisional application No. 63/461,887, filed on Apr. 25, 2023.

(51) Int. Cl. F24C 15/20

(52) U.S. Cl. CPC F24C 15/20

(57) ABSTRACT

A ventilation range hood is disclosed as being comprised at least partially of a mild steel having a first surface with an average surface roughness between 35 micro-inches and 45 micro-inches. One or more layers of substantially clear paint are provided on the first surface. The combination of the average surface roughness and the paint provide the first surface with appearance simulating stainless steel.

### PRIORITY

This Application claims benefit under 35 U.S.C. § 119(e) to U.S. Provisional Application Ser. No. 63/461,887, filed Apr. 25, 2023, which is expressly incorporated by reference herein and made a part hereof.

### BACKGROUND

The present disclosure relates, generally, to process for providing a finish that gives the appearance of stainless steel to a metal that is not stainless steel. More specifically, this disclosure relates to forming a ventilation range hood from a metal other than stainless steel and providing a finish with the appearance of stainless steel.

Additional features of the present disclosure will become apparent to those skilled in the art upon consideration of illustrative embodiments exemplifying certain modes of carrying out the disclosure as presently perceived.

### SUMMARY

A process is disclosed of forming a metal component comprised of a mild steel and having an outer appearance of stainless steel, comprising the steps of (a) providing a piece of mild steel with a first surface; (b) creating a surface roughness on at least a portion of the first surface; and (c) applying at least one layer of paint to the first surface. The process can further comprise the step of forming the piece of mild steel into the metal component. The process can further comprise the step of forming the piece of mild steel into the metal component prior to the step of creating a surface roughness. The step of creating a surface roughness can comprise creating a surface roughness average between 35 micro-inches and 45 micro-inches. The step of creating a surface roughness can comprise creating a plurality of grooves in the first surface of the mild steel component, wherein the grooves are approximately parallel to each other. The step of creating a surface roughness can comprise creating a plurality of grooves in the first surface of the mild steel component, wherein the grooves are approximately straight. The step of creating a surface roughness can comprise creating a plurality of grooves in the first surface of the mild steel component, wherein the grooves define a depth of between 180 micro-inches and 240 micro-inches. The step of applying at least one layer of paint to the first surface can comprise applying a paint that is substantially clear.

A ventilation range hood is disclosed having at least one component comprised of a mild steel, the mild steel component having a first surface and at least a portion of the first surface having a surface roughness defining a surface roughness average between 35 micro-inches and 45 micro-inches; and one or more layers of paint on at least portions of the first surface. The surface roughness can be defined by a plurality of grooves in the first surface of the mild steel component. The surface roughness can be defined by a plurality of grooves in the first surface of the mild steel component and the grooves define a depth of between 180 micro-inches and 240 micro-inches. The surface roughness can be defined by a plurality of grooves in the first surface of the mild steel component and the grooves are approximately straight. The surface roughness can be defined by a plurality of grooves in the first surface of the mild steel component and the grooves are approximately parallel to each other. The one or more layers of paint can define a first side adjacent the first surface and a second side exposed to an ambient environment, wherein the second side defines a surface roughness average different than the surface roughness average of the first surface.

A process of creating a surface finish on a piece of metal comprised of a mild steel to have an outer appearance of stainless steel is disclosed, the process comprising the steps of: (a) providing a piece of metal comprised of a mild steel and having a first surface, (b) treating at least a portion of the first surface with an abrasive object to create a surface finish having a surface roughness defining a surface roughness average between 35 micro-inches and 45 micro-inches, (c) applying at least one layer of paint to the first surface. The abrasive object can be an open web brush comprised of aluminum oxide mineral and nonwoven nylon fibers. The abrasive object can be a rotatable open web brush. The abrasive object can be a rotatable open web brush comprised of aluminum oxide mineral and nonwoven nylon fibers and the step of treating the portion of the first surface with an abrasive object comprises rotating the rotatable open web brush to create a plurality of grooves in the first surface. The grooves can be approximately parallel to each other. The grooves can define a depth of between 180 micro-inches and 240 micro-inches.

### BRIEF DESCRIPTIONS OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A is a perspective view of a ventilation range hood of mild steel after being subjected to the process of the present disclosure.

FIGS. 1B-1D are front, right and left side views of a ventilation range hood of mild steel after being subjected to the step of creating a surface roughness.

FIG. 1E is a cross-section of a portion of the range hood of FIGS. 1B-1D.

FIG. 2 is a flow chart depicting steps of the hood forming process of the present disclosure.

FIG. 3 depicts a roll of mild steel sheet metal;

FIGS. 4A-4B depict a one embodiment of applying a surface roughness to a ventilation range hood;

FIG. 5A is a perspective view of a stainless steel panel.

FIG. 5B is a perspective view of a mild steel panel without any surface treatment according to the present disclosure.

FIG. 5C is the mild steel panel of FIG. 5B with a roughed surface finish according to the present disclosure.

FIG. 5D is the mild steel panel of FIG. 5B with a roughed surface finish, paint and curing performed according to the present disclosure.

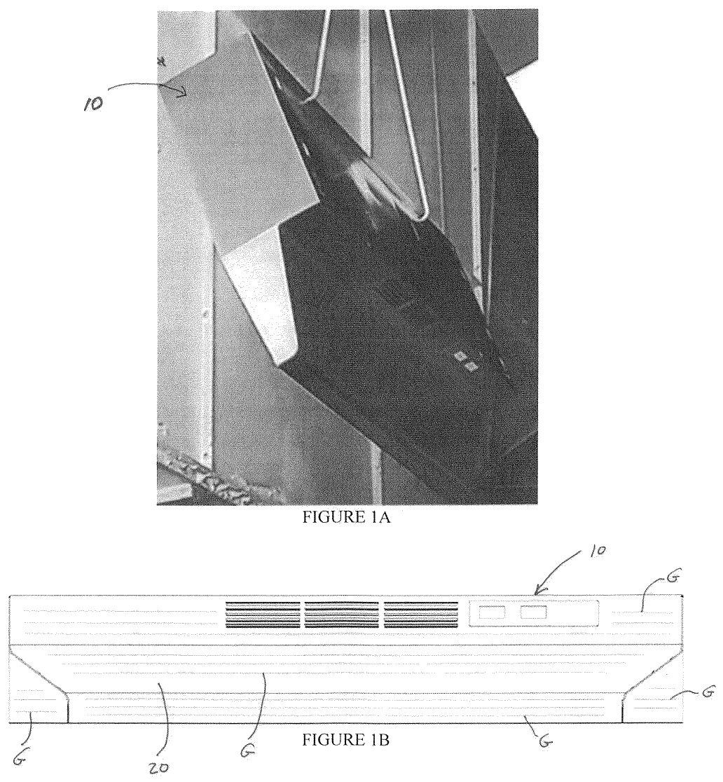

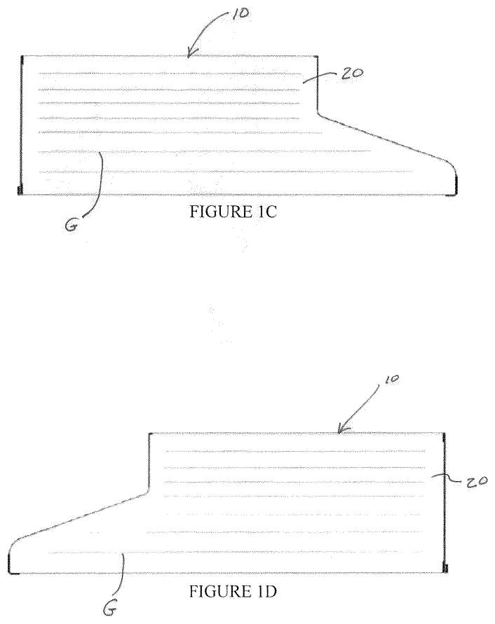

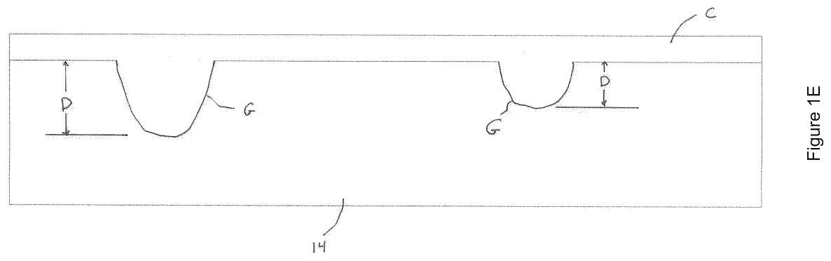

### DETAILED DESCRIPTION

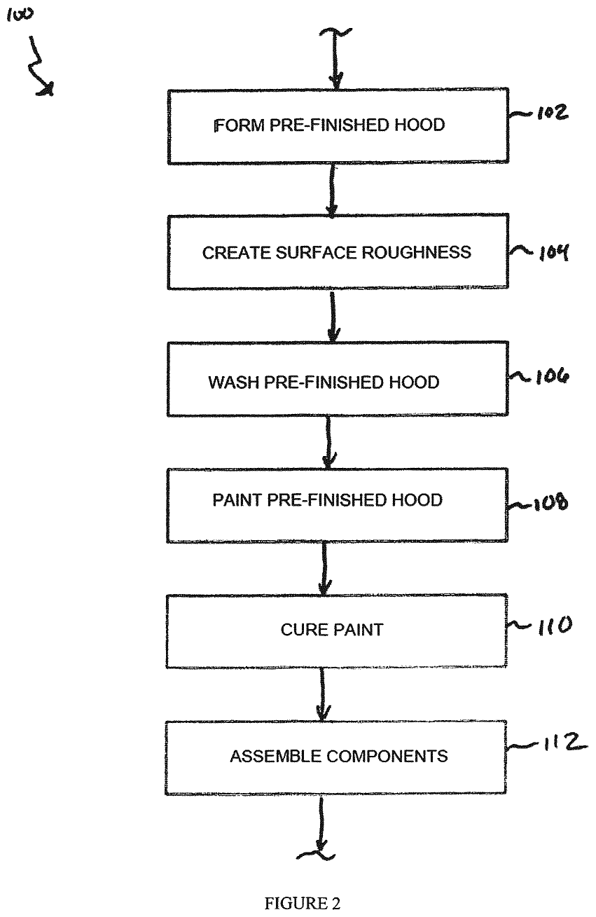

A hood forming process 100 (see FIG. 2) produces a range hood 10 or other metallic component or part from a metal other than stainless steel, but with a finish that simulates the appearance of stainless steel. Although this disclosure focuses on the range hood 10, the process 100 and concepts herein are applicable to any metal object or product. In one embodiment, the range hood 10 is made from a metallic material comprising or consisting of a mild steel. Mild steel (sometimes called “low carbon steel” or “plain carbon steel”) is an iron alloy with carbon as its main alloying element and generally has a lower cost per unit and better machinability/workability than stainless steel. Thus, the process 100 produces range hoods 10 or other metallic components at a lower cost and a higher output or efficiency than other processes that produce stainless steel range hoods or other stainless steel components.

The process 100 includes a step 102 of forming a pre-finished range hood 12 from a sheet of metal 14 (e.g. the mild steel) into the shell of the range hood 10. The step 102 may include unrolling the sheet 14 from a continuous spool as shown in FIG. 3 and transporting the sheet (using a conveyor, a track, or the like) to one or more forming stations. The forming station(s) may do one or more of: trimming the sheet 14 into individual segments, stamping one or more apertures in the sheet, bending the sheet, welding the sheet, fastening portions of the sheet, etc. to provide the pre-finished range hood 12. Other forming steps are contemplated within the scope of this disclosure.

The process 100 further includes a step 104 of creating a surface roughness on at least a portion of a surface 20 of the formed range hood 10. The step 104 of providing a surface roughness is preferably performed after the step 102 of forming the range hood 10 in order to avoid the need of preserving the surface roughness during the forming step 102. However, the step 104 of creating the surface roughness can be performed prior to the forming step 102 so long as measures are taken to maintain the surface roughness during the forming step.

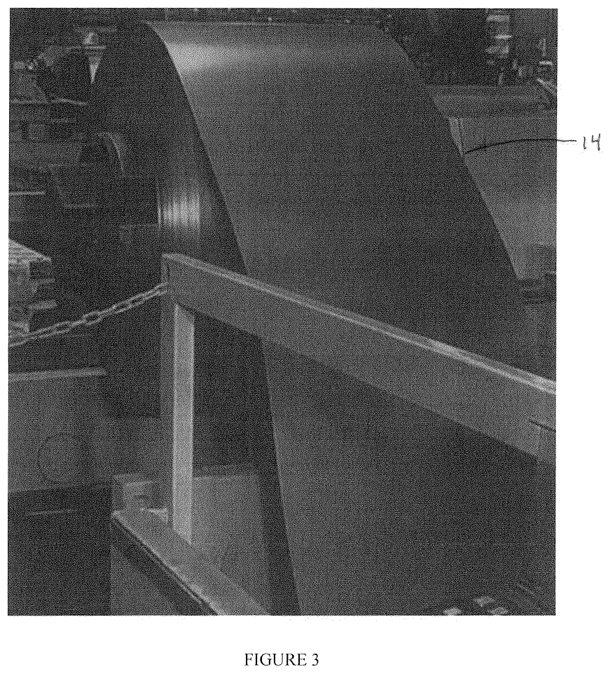

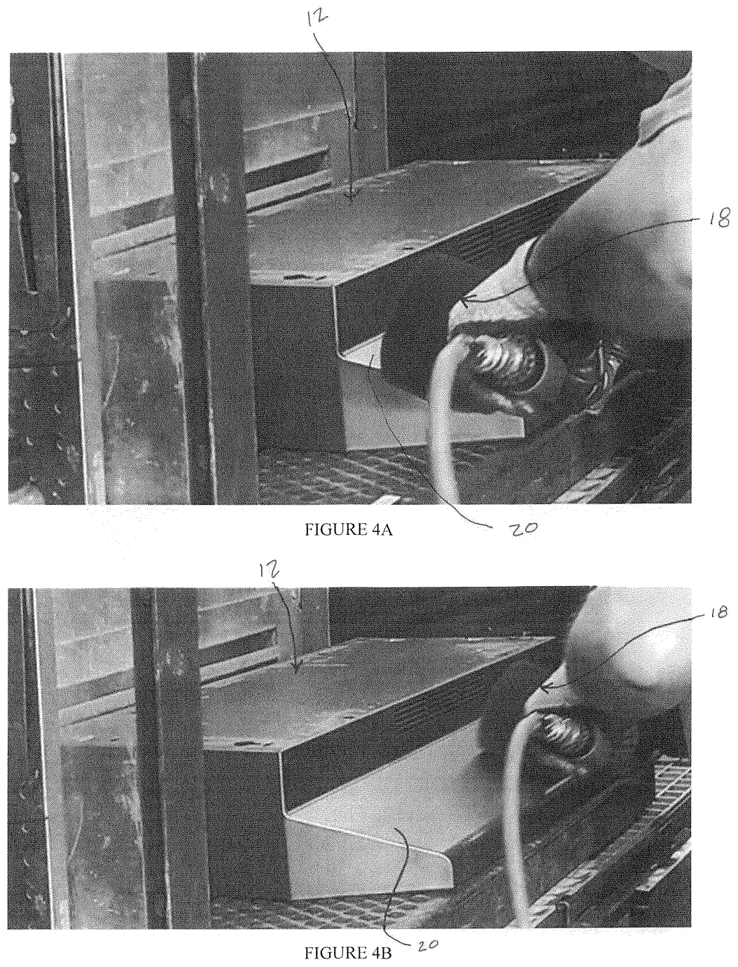

In one embodiment, the surface roughness can be provided by an abrasive object such as by sanding or grinding 104 portions of the surfaces of the formed, but pre-finished range hood 12 as shown in FIGS. 2, 4A, and 4B. Creating the surface roughness is can be done manually (as depicted in FIGS. 4A and 4B) using a hand tool with a grinding drum 18 that rotates about an axis and that passes over at least the outer surfaces 20 of the pre-finished range hood 12 while in contact with the surfaces. Creation of the surface roughness can, alternatively, be done automatically/robotically.

In one embodiment, the grinding drum 18 can be a brush comprised of an open web of aluminum oxide mineral and nonwoven nylon fibers bonded with a resin. Acceptable drums can be obtained from 3M under the name Standard Abrasive, such as Standard Abrasives MD mini-Brush 875711 or 875702 or the like.

The step 104 of creating surface roughness on portions of the surfaces 20 on the pre-finished range hood 12 contributes to simulating the appearance of stainless steel once the range hood 10 is completely finished. In one embodiment, the step 104 of creating surface roughness comprises creating a plurality of grooves G in the surface 20. Preferably, the grooves G are approximately straight and approximately parallel to one another. It has been found that grooves G with a depth D of between 180 micro-inches and 240 micro-inches provides an aesthetic look most closely resembling stainless steel. The grooves G may be of any length. The dimensions and number of grooves G are preferably created to provide an overall surface roughness (sometimes call “Roughness Average” or “Ra”) of between 35 micro-inches and 45 micro-inches on the surface 20.

In one embodiment, the step 104 of creating surface roughness may include applying a pressure within a range of about 5-15 lbs. on the pre-finished range hood 12 with the grinding drum 18. In the case of an automated grinding step, a pressure sensor can be included to monitor the pressure applied on the pre-finished range hood 12.

In one embodiment, the step 104 of creating surface roughness only creates surface roughness on portions of the sheet metal 14 that will be visible to a user of the final finished product, such as the range hood 10. The surface roughness can, in other embodiments, be applied to all surfaces of the sheet metal 14, but efficiencies will be recognized by applying the surface roughness only to the surfaces that will ultimately be viewable to a consumer.

The process 100 further includes a step 106 of washing the pre-finished range hood 12. The step of washing includes spraying the pre-finished range hood 12 with a solution that removes dust, shavings, debris, oil, grease, etc. from the pre-finished range hood 12. In one example, the solution is ULTRAX EC812W manufactured by Pretreatment and Specialty Products located at 23000 St. Clair Avenue Euclid, OH 44117. The step 106 of washing may further include one or more steps of washing the pre-finished range hood 12 with reverse osmosis (RO) water after washing with the solution. In one embodiment, the pre-finished range hood 12 is rinsed up to 5 times with RO water. This prepares the pre-finished range hood 12 for coating with a paint.

The process 100 further includes a step 108 of painting or coating the pre-finished range hood 12. The step 108 of painting or coating can be performed using a robotic/automatic arm with a spray head attached thereto. In one embodiment, the spray head is a 50 mm ABB Robot Rotating Cup 2N2023 Bell cup and includes an internal, rotating bell that atomizes paint or coating fluid. In another embodiment the spray head is a 30 mm ABB Robot Rotating Cup 1N1886Bell cup. An article titled “Automotive Rotary-Bell Spray Painting” by Lucas Ariel Martinez of the University of Gothenburg is hereby incorporated by reference herein in its entirety for the purpose of describing one or more methods of spray painting metal with a spray head that has a rotating bell. The atomized fluid is discharged onto at least the textured surfaces 20 of the pre-finished range hood 12 to coat the pre-finished range hood 12.

Regardless of the painting process, the paint used to provide a coat C, the pre-finished range hood 12 can include a clear coating to simulate untreated stainless steel or a grey or black pigmented coating to simulate black stainless steel. In the illustrative embodiment a single coating C is applied at a thickness within a range of about 0.9-1 mil. The paint may have a glossy look and may or may not be opaque. The tint can be varying in terms of shade and opacity. Whether black stainless or regular stainless, the process is a single stage coating step with either clear coating or grey/black coating. In alternative embodiments, the process may include applying a clear coating mixed with the pigmented paint in a two-stage step or one-stage step. In some embodiments, the bell of the spray head is rotated at a higher rate for the clear coating compared to the grey/black coating.

The clear coating may have the following properties/characteristics:
Pounds per Gallon: 8.83±0.30
% Weight Solids: 50.85±2.0
% Volume Solids: 46.19±1.0
Viscosity: 14-17 sec. @#3 Zahn
Reducer: Methyl Acetate (if needed)
Theoretical Coverage—sq. ft./gal.
@ 1.0 mil DFT (no loss): 740.90
VOC: 2.96
DFT: 0.80-1.20 mils

The process 100 further includes a step 110 of curing the paint or coating C, for example, in an oven. For the clear coating, the step 110 may be performed at a temperature within a range of about 325 degrees Fahrenheit (F) to about 345 degrees F. and for a duration within a range of about 18 minute to about 20 minutes. For the grey/black coating, the step 110 may be performed at a temperature within a range of about 355 degrees F. to about 375 degrees F. and for a duration within a range of about 18 minute to about 20 minutes. The step 110 may be performed at any temperature or duration at or within said ranges. The temperature and durations noted above may have a tolerance of 5%. Exceeding these ranges may result in a yellow and/or darkened tint to the paint, which is undesirable as this would not simulate stainless steel. In some embodiments, the painting and curing steps are performed within 2-3 days of the sanding step to avoid oxidation/rusting. The step of curing also reduces the likelihood that the paint can become imprinted due to lack of curing.

After exiting the oven and cooling, the process 100 may further include one or more steps 112 of assembling components onto the finished range hood. The components added to the range hood 10 may include one or more of control panels, wires, trim, vents, filters, etc.

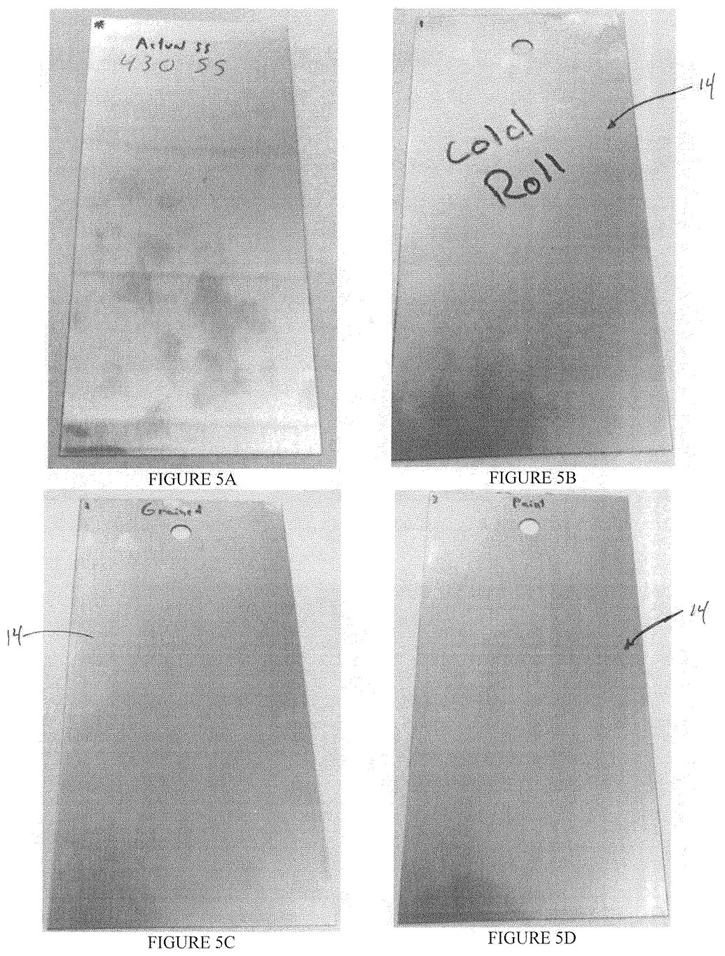

FIG. 5A shows a stainless steel panel. FIG. 5B shows the sheet 14 of metal prior to being sanded. FIG. 5C shows the sheet 14 after being sanded. FIG. 5D shows the sheet 14 after being painted and cured.

It should be noted that the various components and features described above can be combined in a variety of ways, so as to provide other non-illustrated embodiments within the scope of the disclosure. As such, it is to be understood that the disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation.

Although the present disclosure has been described in the foregoing description by way of illustrative embodiments thereof, these embodiments can be modified at will, without departing from the spirit, scope, and nature of the subject disclosed.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. In addition, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

In one aspect, a term coupled or the like may refer to being directly coupled. In another aspect, a term coupled or the like may refer to being indirectly coupled. Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The use of the terms “a” and “an” and “the” and “said” and similar references in the context of describing the invention (especially in the context of the following claims) are to be construed to cover both the singular and the plural, unless otherwise indicated herein or clearly contradicted by context. An element proceeded by “a,” “an,” “the,” or “said” does not, without further constraints, preclude the existence of additional same elements. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

1. A process of forming a metal component comprised of a mild steel and having an outer appearance of stainless steel, comprising the steps of:
(a) providing a piece of mild steel with a first surface;
(b) creating a surface roughness on at least a portion of the first surface; and
(c) applying at least one layer of paint to the first surface.

2. The process of claim 1, further comprising the step of forming the piece of mild steel into the metal component.

3. The process of claim 1, further comprising the step of forming the piece of mild steel into the metal component prior to the step of creating a surface roughness.

4. The process of claim 1, wherein the step of creating a surface roughness comprises creating a surface roughness average between 35 micro-inches and 45 micro-inches.

5. The process of claim 1, wherein the step of creating a surface roughness comprises creating a plurality of grooves in the first surface of the mild steel component, wherein the grooves are approximately parallel to each other.

6. The process of claim 1, wherein the step of creating a surface roughness comprises creating a plurality of grooves in the first surface of the mild steel component, wherein the grooves are approximately straight.

7. The process of claim 1, wherein the step of creating a surface roughness comprises creating a plurality of grooves in the first surface of the mild steel component, wherein the grooves define a depth of between 180 micro-inches and 240 micro-inches.

8. The process of claim 1, wherein the step of applying at least one layer of paint to the first surface comprises applying a paint that is substantially clear.

9. A ventilation range hood having at least one component comprised of a mild steel:
the mild steel component having a first surface and at least a portion of the first surface having a surface roughness defining a surface roughness average between 35 micro-inches and 45 micro-inches;
one or more layers of paint on at least portions of the first surface.

10. The ventilation range hood of claim 9, wherein the surface roughness is defined by a plurality of grooves in the first surface of the mild steel component.

11. The ventilation range hood of claim 9, wherein the surface roughness is defined by a plurality of grooves in the first surface of the mild steel component and the grooves define a depth of between 180 micro-inches and 240 micro-inches.

12. The ventilation range hood of claim 9, wherein the surface roughness is defined by a plurality of grooves in the first surface of the mild steel component and the grooves are approximately straight.

13. The ventilation range hood of claim 9, wherein the surface roughness is defined by a plurality of grooves in the first surface of the mild steel component and the grooves are approximately parallel to each other.

14. The ventilation range hood of claim 9, wherein the one or more layers of paint define a first side adjacent the first surface and a second side exposed to an ambient environment, wherein the second side defines a surface roughness average different than the surface roughness average of the first surface.

15. A process of creating a surface finish on a piece of metal comprised of a mild steel to have an outer appearance of stainless steel, the process comprising the steps of:
(a) providing a piece of metal comprised of a mild steel and having a first surface;
(b) treating at least a portion of the first surface with an abrasive object to create a surface finish having a surface roughness defining a surface roughness average between 35 micro-inches and 45 micro-inches;
(c) applying at least one layer of paint to the first surface.

16. The process of claim 15, wherein the abrasive object is an open web brush comprised of aluminum oxide mineral and nonwoven nylon fibers.

17. The process of claim 15, wherein the abrasive object is a rotatable open web brush.

18. The process of claim 15, wherein the abrasive object is a rotatable open web brush comprised of aluminum oxide mineral and nonwoven nylon fibers and the step of treating the portion of the first surface with an abrasive object comprises rotating the rotatable open web brush to create a plurality of grooves in the first surface.

19. The process of claim 18, wherein the grooves are approximately parallel to each other.

20. The process of claim 18, wherein the grooves define a depth of between 180 micro-inches and 240 micro-inches.
